(19) United States
(12) Patent Application Publication
(10) Pub. No.: US 2024/0404309 A1
(43) Pub. Date: Dec. 5, 2024

(54) Computer Vision Systems and Methods for Information Extraction from Inspection Tag Images

(71) Applicant: Insurance Services Office, Inc., Jersey City, NJ (US)

(72) Inventors: Venkata Subbarao Veeravarasapu, Munich (DE); Ashwani Khemani, Bellevue, WA (US); Surya Venteddu, Edison, NJ (US); Zheng Zhong, Seattle, WA (US); Shane De Zilwa, Danville, CA (US); Talmor Meir, Brooklyn, NY (US); Keith Lew, Larchmont, NY (US)

(73) Assignee: Insurance Services Office, Inc., Jersey City, NJ (US)

(21) Appl. No.: 18/672,799

(22) Filed: May 23, 2024

Related U.S. Application Data
(60) Provisional application No. 63/468,659, filed on May 24, 2023.

(51) Int. Cl. G06V 30/41; G06V 10/764; G06V 30/12; G06V 30/146; G06V 30/148; G06V 30/18; G06V 30/42

(52) U.S. Cl. CPC G06V 30/41; G06V 10/764; G06V 30/133; G06V 30/1463; G06V 30/148; G06V 30/18; G06V 30/42

(57) ABSTRACT

Computer vision systems and methods for information extraction from inspection tag images are provided. The system receives an image of an inspection tag, detects one or more tags in the image, crops and aligns the image to focus on the detected one or more tags, and processes the cropped and aligned image to automatically extract information from the depicted inspection tag. Each tag identified by the system can be bounded by a tag-box that bounds the detected tag, and a tag quality score can be calculated for each tag-box. One or more visual features can be extracted after cropping of the image, and pixel-level prediction can be performed on the image to predict and/or correct an orientation of the image. Word-level and line-level optical character recognition (OCR) is then performed on the cropped and aligned image of the tag in order to extract a plurality of information from the tag.

### RELATED APPLICATIONS

The present application claims priority of U.S. Provisional Patent Application Ser. No. 63/468,659 filed on May 24, 2023, the entire disclosure of which is expressly incorporated herein by reference.

### FIELD OF THE DISCLOSURE

The present disclosure relates generally to the field of computer vision. More specifically, the present disclosure relates to computer vision systems and methods for information extraction from inspection tag images.

### RELATED ART

Inspection tags are paper or other tags that are attached to items that require periodic inspection, such as fire extinguishers, valves, hoses, and other equipment. Often, such tags include various indicia such as the name of the company performing the inspection, company address, date (e.g., year and/or month) of inspection, the name of the individual performing the inspection, information about the inspected object, and other relevant information. Additionally, one or more regions of inspection tags are often physically “punched” (e.g., portions of the tag are removed) to indicate a date (e.g., year/month) when the last inspection was performed. As can be appreciated, inspection tags record important information regarding the operational status and safety of associated equipment.

Information from inspection tags is generally manually obtained by insurance adjusters and other individuals performing site visits in connection with a dwelling/location, such that the adjuster or other individually reads the inspection tag and writes down relevant information from the tag, which information is then subsequently used for various insurance adjusting and other functions. However, this process is time-consuming and prone to error. With the advent of computer vision and machine learning technology, it would be highly beneficial to provide a system which automatically processes an image of an inspection tag (e.g., taken by a camera of a smart phone or other device) and automatically extracts relevant information from the tag, so as to significantly speed up the process of acquiring important inspection information at a facility and to also improve the accuracy of the information extraction from such tags.

Accordingly, what would be desirable are computer vision systems and methods for information extraction from inspection tag images which solve the foregoing and other needs.

### SUMMARY

The present disclosure relates to computer vision systems and methods for information extraction from inspection tag images. The system receives an image of an inspection tag, detects one or more tags in the image, crops and aligns the image to focus on the detected one or more tags, and processes the cropped and aligned image to automatically extract information from the depicted inspection tag. Each tag identified by the system can be bounded by a tag-box that bounds the detected tag, and a tag quality score can be calculated for each tag-box. A tag-box with the highest score can be selected for processing (e.g., for cropping and alignment of the tag depicted in the tag-box). One or more visual features can be extracted after cropping of the image, and pixel-level prediction can be performed on the image to predict and/or correct an orientation of the image. Word-level and line-level optical character recognition (OCR) is then performed on the cropped and aligned image of the tag in order to extract a plurality of information from the tag, such as date (e.g., year/month) of inspection indicated in the tag, company name, address, phone number, information about the inspected object, and other relevant information.

### BRIEF DESCRIPTION OF THE DRAWINGS

The foregoing features of the disclosure will be apparent from the following Detailed Description, taken in connection with the accompanying drawings, in which:

FIG. 1 is a diagram illustrating the system of the present disclosure;

FIG. 2 is a diagram illustrating processing by the system of an image of an inspection tag to automatically extract one or more attributes relating to a tagged object;

FIG. 3 is a flowchart illustrating processing steps carried out by the system of the present disclosure;

FIGS. 4A-4C are images illustrating detection by the system of the present disclosure of an inspection tag and an associated tagged object in an image;

FIG. 5 illustrates a comparison of an image of an inspection tag and text information automatically extracted from the image of the inspection tag by the system of the present disclosure;

FIG. 6 is a table illustrating performance characteristics of the system of the present disclosure; and

FIGS. 7A-7D illustrate cropping of an inspection tag image and information extraction performed by the system of the present disclosure.

### DETAILED DESCRIPTION

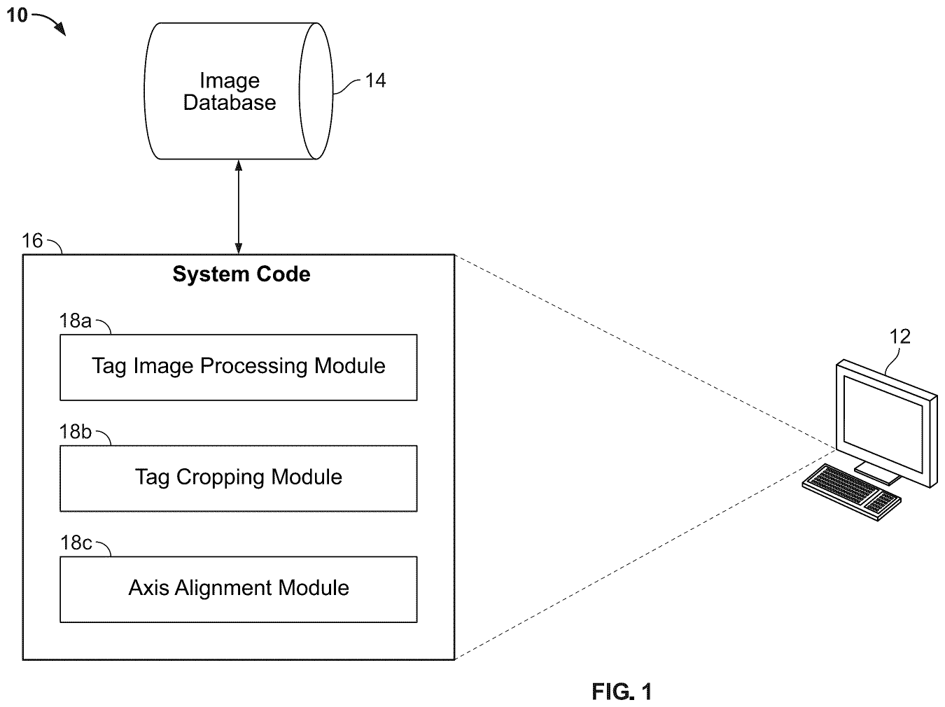

The present disclosure relates to computer vision systems and methods for analyzing images of inspection tags, as described in detail below in connection with FIGS. 1-7D.

FIG. 1 is a diagram illustrating the system of the present disclosure, indicated generally at 10. The system 10 includes a computer system 12 in communication with an image database 14 and executing system code 16 which performs the functions described herein. More specifically, the system code 16 includes a tag image processing module 18a which obtains one or more images of a tagged object from the image database 14, a tag cropping module 18b which crops the one or more images of the tagged object, and an axis alignment module 18c which aligns an axis of the one or more images of the tagged object and extracts information from the aligned and cropped one or more images. Functionality of each of the modules 18a-18c is described in detail in below. The system code 16 could be embodied as computer-readable instructions stored on a non-transitory, computer-readable medium such as a memory (including, but not limited to, disc memory, non-volatile (e.g., flash) memory, random-access memory, read-only memory, etc.) of the computer system 12, and executed by a processor of the computer system 12. Additionally, the system code 16 could be programmed in any suitable high- or low-level language including, but not limited to, C, C++, C#, Java, Javascript, Python, Go, Ruby, or any other suitable programming language.

It is noted that the computer system 12 could be any suitable computing device including, but not limited to, a smart phone, a tablet computer, a laptop computer, a desktop computer, a server, a cloud computing platform, an embedded processor, or any other suitable computing device. The image database 14 could also be stored in a memory of the computer system 12 and accessed by a processor of the computer system 12, or stored separate from (e.g., external to) the computer system 12, e.g., on one or more database servers or other computer systems in communication with the computer system 12. Additionally, the computer system 12 and the image database 14 could be in communication via a wired or wireless network, including but not limited to, an intranet, the Internet, a local area network (LAN), a wide area network (WAN), or other form of communication.

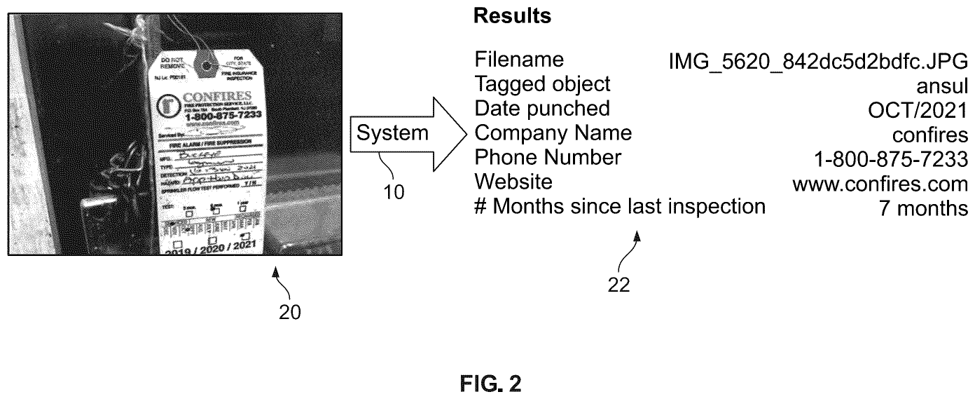

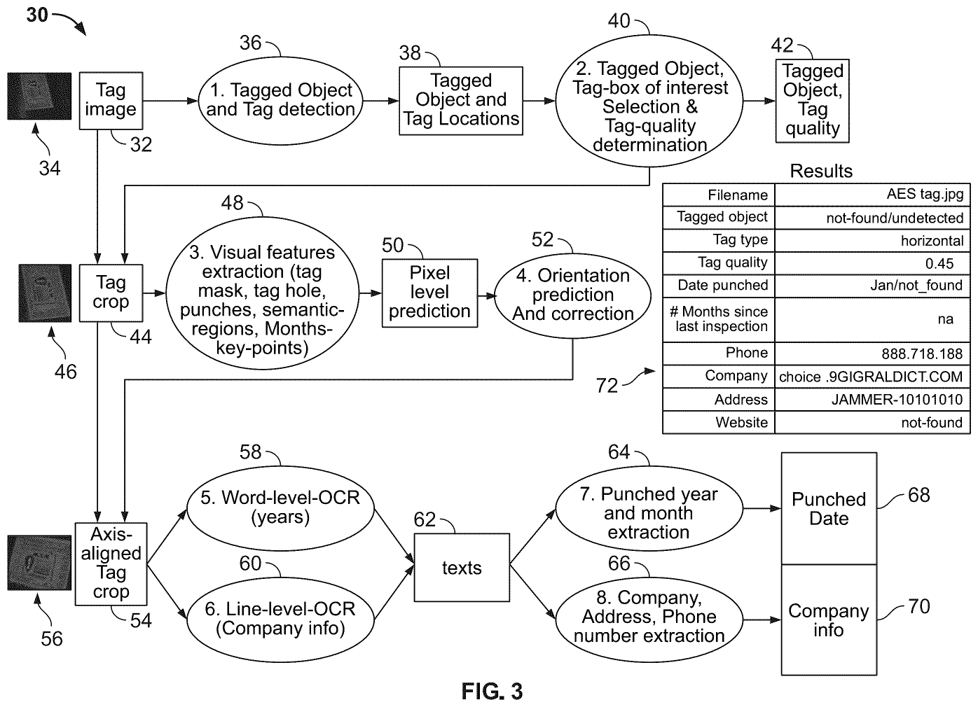

FIG. 2 is a diagram illustrating processing by the system 10 of an image 20 of an inspection tag to automatically extract one or more attributes 22 relating to a tagged object. As will be described in greater detail below in connection with FIG. 3, the system 10 obtains the image 20, processes the image using a computer vision algorithm to identify an inspection tag in the image, crops the image, aligns an axis of the image, and extracts information from the inspection tag in the image in the form of textual (e.g., alphabetic, numeric, and/or alphanumeric) data fields which include information relating to an object corresponding to the tagged image.

FIG. 3 is a flowchart illustrating processing steps carried out by the system of the present disclosure, indicated generally at 30. Beginning in step 32, the system obtains an image 34 of a tagged object, e.g., from the image database 14 of FIG. 1. In step 36, the system processes the image 34 to detect a tagged object as well as the location of the tag in the image, generating an output 38 which includes both an indication of the tagged object and the tag location in the image. Next, in step 40, the system processes the tagged object to generate a tag-box of interest (e.g., a bounding box around one or more potential tags identified in the image). If more than one tag is identified in the image, tag-boxes are generated for each candidate tag and the system selects one of the tag-boxes. Additionally, the system identifies the quality of each tag bounded by each tag-box, and generates an output 42 which identifies the tagged object and the quality of the tag.

If no tag-box is detected, the system exits the process. Otherwise, if only one tag-box is detected, the tag in that tag-box is identified as the tag of interest. If multiple tag-boxes are detected, the one with the highest confidence score becomes the tag of interest. Tag quality for each tag-box is computed as a ratio between the tag-box area and the area of the image, as follows:

$${Q}_{T} = ( {h}_{b} \times {w}_{b} ) / ( H \times W )$$

where h_{b} and w_{b} are the height and width of the tag-box, and H and W are the height and width of the image. If the image is completely focused on the tag, then the tag quality tends toward a value of 1.

In step 44, the system crops the image to generate a cropped image 46, such that the tag region is cropped out using the box-of-interest and is fed to subsequent modules. Next, in step 48, the system processes the cropped image to extract one or more features from the image, including, but not limited to, a tag mask, a tag hole (e.g., one or more physical holes in the tag depicted in the cropped image), one or more punches in the tag, one or more semantic regions of the tag, and one or more key points indicating a month or other time or date indicator. Specifically, features are extracted from the tag that are used to correct the tag alignment, as well as the punched date on the tag. It is noted that a DeepLabv3 model can be trained and utilized in this step to generate a plurality of visual features.

Next, in step 50, the system performs a pixel-level prediction on the extracted features. Then, in step 52, the system predicts an orientation and a correction for the image, which is then processed in step 54 to perform an axis alignment on the cropped image to generate an axis-aligned image 56. Specifically, border point estimates can be used and mask prediction maps can be generated to estimate the four corners of a depicted tag, and perspective projective transformation can be performed to align the corners of the tag to the corners of the image. Detected visual features an also be transformed using a transformation matrix. In step 58, the system performs word-level optical character recognition (OCR) on the axis-aligned image 56 in order to determine an inspection year (e.g., 2023) and other words indicated on the tag depicted in the image. Additionally, in step 60, the system performs line-level OCR on the axis-aligned image 56 to identify a company indicated on the tag depicted in the image, as well as other information.

In step 62, the system combines the identified word-level and line-level information into one or more blocks of text. In step 64, the system extracts a punched year and a punched month. A “regex” filter can be used to detect all year-like text from all text segments detected via OCR. If only a single year is detected, that year can be identified by the system as the inspection year for the tagged object. If multiple years are detected, the system can detect distances with pairs of year boxes and punches on the tags, and the pair that has the minimum distance can be identified as the punched (inspection) year. To identify the inspection month, a similar approach can be utilized, such that distances between the month key points and punches can be computed and the pair with the minimum distance can be identified as the punched (inspection) month.

In step 66, the system extracts a company, address, and telephone number, and outputs the punched date as output 68 and company information as output 70. The system classifies all text segments generated by optical character recognition into classes of company name, address, phone number, and any other applicable information. Natural language processing (NLP)-based models can also be utilized to perform these steps, alone or in combination with visual structures that provide extraction cues. Probability maps can be computed for pixel-level locations of these classes of information, and class labels can be attached to each text segment based on dominant pixel types in the probability maps.

Finally, the outputs 42, 68, and 70 can be combined into an output table 72 that identifies a variety of information from the tag, including, but not limited to, a file name, an indication of the tagged object (e.g., fire extinguisher), a tag type (e.g., vertical or horizontal tag), a tag quality (e.g., a numeric score indicating the quality of the tag), a date the tag was punched, number of months left since the last inspection, a telephone number, a company name, a company address, and a website identifier (e.g., URL). It is noted that the processes described in FIG. 3 need not be executed serially, and that a number of the processes could be executed in parallel. Additionally, it is noted that the various machine learning models described herein can be trained using a suitable pipeline of images, and validation sets can be utilized using a plurality of validation images.

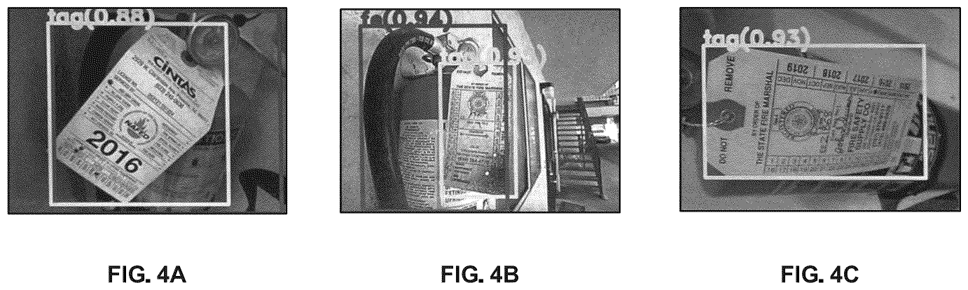

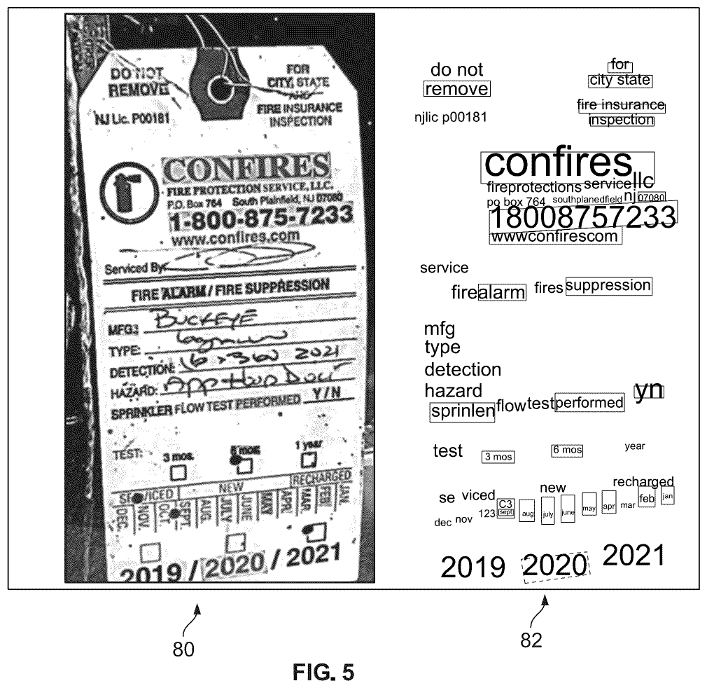

FIGS. 4A-4C are images illustrating detection by the system of the present disclosure of an inspection tag and an associated tagged object in an image. Specifically, as shown in FIG. 4A, a tag-box (bounding box) is generated by the system around a depicted tag, and a tag quality score (e.g., 0.88) is calculated and displayed next to the tag-box, indicating the overall quality of the detected tag. As shown in FIG. 4B, another bounding box is displayed around the detected object, in this case, around a detected fire extinguisher, and a tag-box is displayed around the inspection tag corresponding to the detected object. Both boxes include quality scores. As shown in FIG. 4C, the system can detect a horizontally-oriented tag and can generate a tag-box and associated quality score for the horizontally-oriented tag.

FIG. 5 illustrates a comparison of an image 80 of an inspection tag and text information 82 automatically extracted from the image 80 of the inspection tag by the system of the present disclosure. As can be seen, the tag in the image 80 includes information such as the name of a company (“Confires Fire Protection Service, LLC”), a telephone number, a website, a manufacturer name, a type of equipment, and other information as well as punched areas of the tag that indicate testing/inspection dates. After processing by the system, this information is extracted in textual form in the text information 82.

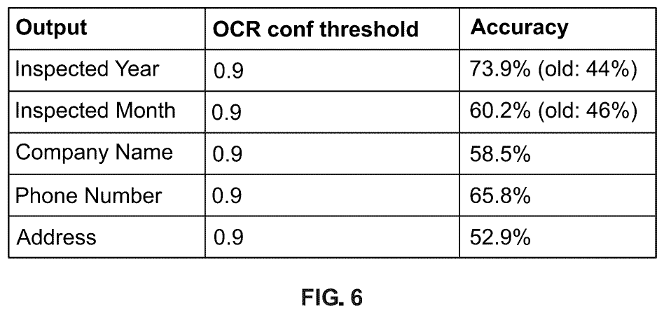

FIG. 6 is a table illustrating performance characteristics of the system of the present disclosure. As can be seen, various outputs such as the inspected year, the inspected month, company name, phone number, and address each have associated OCR confidence thresholds as well as accuracy scores.

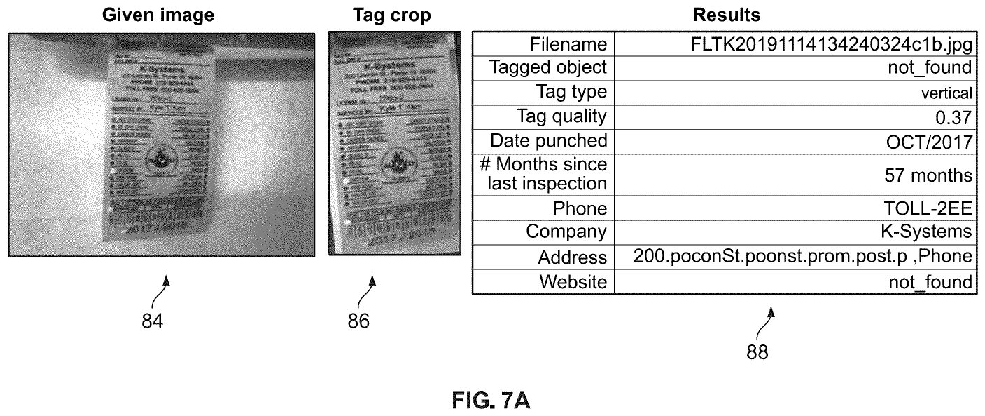

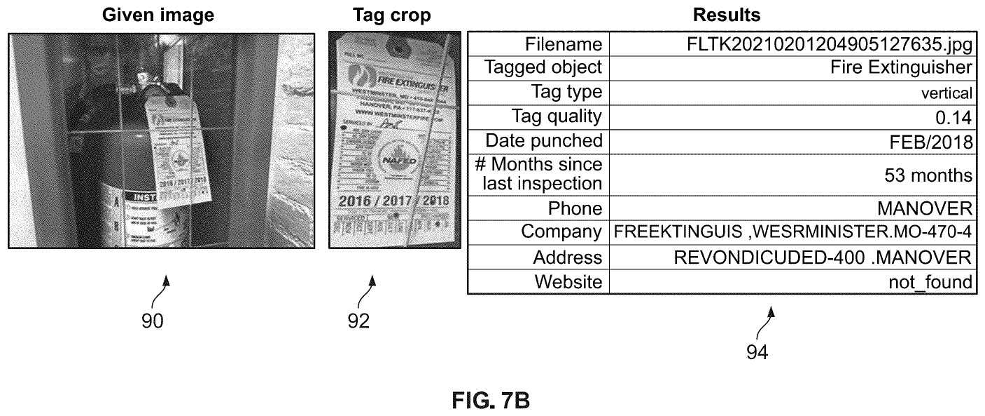

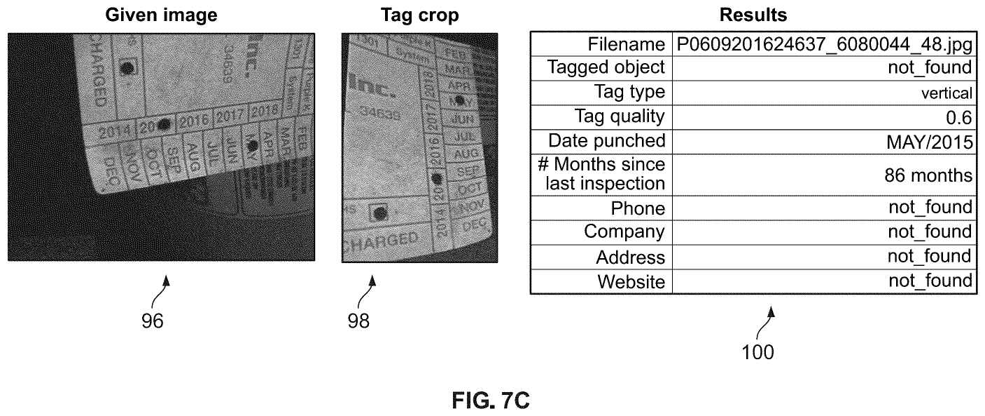

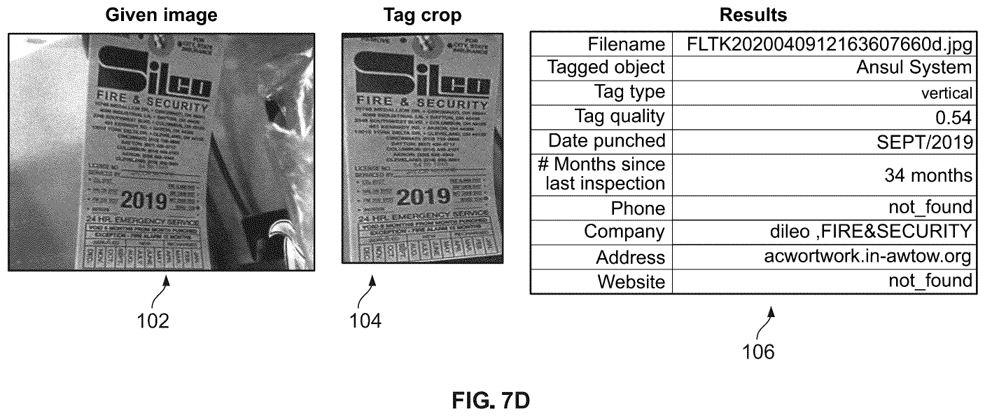

FIGS. 7A-7D illustrate cropping of an inspection tag image and information extraction performed by the system of the present disclosure. As shown in FIG. 7A, the given image 84 is cropped into a cropped image 86, and results 88 are generated which include textual (e.g., alphanumeric information) extracted from the tag. The given image 84 include only the inspection tag. As shown in FIG. 7B, the given image 90 could include both the inspection tag and the detected object corresponding to the inspection tag, such as a fire extinguisher. The system crops the image 84 to produce a cropped image 92 that displays just the tag, and the cropped image is processed to extract the results 94. As shown in FIG. 7C, the given image 96 is an image of only a portion of an inspection tag that is oriented horizontally, which is cropped and aligned by the system to produce the cropped image 98 and the textual results 100. Finally, as shown in FIG. 7D, the given image 102 includes a vertically-oriented tag, which is then cropped to produce cropped image 104 and textual results 106 generated from the cropped image 104.

Although the systems and methods of the present disclosure have been described in connection with extracting information from inspection tags, it is noted that the systems and methods described herein could also be utilized in connection with identifying and extracting information from other types of tags and/or paper-based indicia. Additionally, such information need not be limited to inspection information, and could indeed be applied to a wide variety of information extraction of various types.

It is noted that the systems and methods of the present disclosure could be extended to identify the location of a particular photo of an inspection tag, such as a geocode, global positioning system (GPS) coordinates, or other location information. Such location information could be useful in verifying that the photo of the inspection tag is genuine, and that the image was taken at the actual location of the inspection tag. Additionally, the system could compare one or more inspection tag images with images of inspection tags at the same location or another location, so as to verify the authenticity of the detected inspection tag. Further, additional attributes of the inspection tag could be detected, such as the approximate age of the inspection (e.g., due to detected conditions of the tag such as the condition of the paper or material forming the inspection tag, etc.). Still further, the system could utilize computer vision techniques to identify the type of a tagged object from the image (e.g., a fire extinguisher) and could compare the type of the detected object to an object type indicated on the inspection tag, in order to verify that the inspection tag corresponds to the correct object.

It is additionally noted that the systems and methods of the present disclosure could be utilized to resolve ambiguous punch locations or resolution in an image of an inspection tag. For example, if the location of the punch is not immediately clear (e.g., the tag is punched on a line between two different month boxes, or the punch spans two boxes), the system could utilize machine learning to resolve the correct location of the punch. For example, the system could determine which side of the line the punch is closer to using a model that is trained on multiple tags. Also, if there are multiple tags in the same building with the same punch date but in different spots, the system could select an inspection date as the date that is most clear and/or common and/or sensible.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

What is claimed is:

1. A computer vision system for extracting information from an inspection tag, comprising:
a processor in communication with a memory, the processor programmed to perform the steps of:
receiving an image of an inspection tag from the memory;
process the image to detect one or more tags in the image;
cropping and aligning the image to focus on the detected one or more tags; and
process the cropped and aligned image to automatically extract information from the detected one or more tags.

2. The system of claim 1, wherein the processor is further programmed to perform the step of bounding each of the one or more tags by a tag-box.

3. The system of claim 2, wherein the processor is further programmed to perform the step of calculating a tag quality score for the tag-box.

4. The system of claim 3, wherein the tag quality score is computed by the processor as a ratio between a tag-box area and an image area.

5. The system of claim 3, wherein the processor is further programmed to perform the step of selecting a tag-box having a highest tag quality score.

6. The system of claim 5, wherein the processor is further programmed to perform the step of cropping and aligning a tag depicted in the tag-box.

7. The system of claim 1, wherein the processor is further programmed to perform the step of extracting one or more visual features after cropping and alignment of the image.

8. The system of claim 1, wherein the processor is further programmed to perform the step of performing pixel-level prediction on the image to predict or correct an orientation of the image.

9. The system of claim 1, wherein the processor is further programmed to perform the step of performing one or more of word-level or line-level optical character recognition on the cropped and aligned image to extract the information from the one or more detected tags.

10. The system of claim 1, wherein the information extracted from the one or more detected tags includes one or more of a date of inspection, a company name, an address, a telephone number, or information about an inspected object.

11. The system of claim 1, wherein the processor is further programmed to determine a location where the image was taken and processes the location to determine whether the image is genuine.

12. The system of claim 1, wherein the processor compares the image to a second image to determine authenticity of the image.

13. The system of claim 1, wherein the processor is further programmed to perform the step of determining an approximate age of an inspection by detecting a condition of the one or more tags.

14. The system of claim 1, wherein the processor is further programmed to perform the step of identifying from the image a type of an object corresponding to the one or more tags to verify that the one or more tags corresponds to the object.

15. The system of claim 1, wherein the processor is further programmed to perform the step of resolving an ambiguous punch location of the one or more tags.

16. A computer vision method for extracting information from an inspection tag, comprising the steps of:
receiving by a processor an image of an inspection tag stored in memory;
process the image by the processor to detect one or more tags in the image;
cropping and aligning the image by the processor to focus on the detected one or more tags; and
process the cropped and aligned image by the processor to automatically extract information from the detected one or more tags.

17. The method of claim 16, further comprising bounding each of the one or more tags by a tag-box.

18. The method of claim 17, further comprising calculating a tag quality score for the tag-box.

19. The method of claim 18, wherein the tag quality score is computed by the processor as a ratio between a tag-box area and an image area.

20. The method of claim 18, further comprising selecting a tag-box having a highest tag quality score.

21. The method of claim 20, further comprising cropping and aligning a tag depicted in the tag-box.

22. The method of claim 16, further comprising extracting one or more visual features after cropping and alignment of the image.

23. The method of claim 16, further comprising performing pixel-level prediction on the image to predict or correct an orientation of the image.

24. The method of claim 16, further comprising performing one or more of word-level or line-level optical character recognition on the cropped and aligned image to extract the information from the one or more detected tags.

25. The method of claim 16, wherein the information extracted from the one or more detected tags includes one or more of a date of inspection, a company name, an address, a telephone number, or information about an inspected object.

26. The method of claim 16, further comprising determining a location where the image was taken and processes the location to determine whether the image is genuine.

27. The method of claim 16, further comprising comparing the image to a second image to determine authenticity of the image.

28. The method of claim 16, further comprising determining an approximate age of an inspection by detecting a condition of the one or more tags.

29. The method of claim 16, further comprising identifying from the image a type of an object corresponding to the one or more tags to verify that the one or more tags corresponds to the object.

30. The method of claim 16, further comprising resolving an ambiguous punch location of the one or more tags.
